(19) United States
(12) Patent Application Publication
(10) Pub. No.: US 2019/0185347 A1
(43) Pub. Date: Jun. 20, 2019

(54) Portable Water Filtration Assembly

(71) Applicant: Kenneth Murrell, Dublin, VA (US)

(72) Inventor: Kenneth Murrell, Dublin, VA (US)

(21) Appl. No.: 16/225,518

(22) Filed: Dec. 19, 2018

Related U.S. Application Data
(60) Provisional application No. 62/608,276, filed on Dec. 20, 2017.

(51) Int. Cl. C02F 1/00; B01D 29/21; B01D 29/56; B01D 35/30

(52) U.S. Cl. CPC C02F 1/003; C02F 1/002; B01D 29/216; B01D 29/56; B01D 2201/303; C02F 2307/10; C02F 2201/004; C02F 2201/007; C02F 2201/008; B01D 35/30

(57) ABSTRACT

A split case adapted to hold water filtration units in a water filtration subassembly. The interior of the case holds three water filtration units arranged in series. The filtration units are in fluid communication with each other through fluid connectors. The assembly includes a water input member and a water output member, each generally positioned at opposing ends of the split case, each partially exposed to the space outside the case through apertures in the walls of the split case, and each providing fluid communication between the outside world and the water filtration subassembly.

### CROSS-REFERENCE TO RELATED APPLICATIONS

This Application claims the benefit of the filing date of U.S. Provisional Patent Application Ser. No. 62/608,276, filed Dec. 20, 2017, the entire content of which is herein incorporated.

### STATEMENT REGARDING FEDERALLY SPONSORED RESEARCH OR DEVELOPMENT

Not Applicable

### BACKGROUND OF THE INVENTION

### 1. Field of Invention

The present invention pertains generally to water filtration systems and, more particularly, to readily transportable assemblies for employing multiple water filtration elements in series.

### 2. Description of the Related Art

Water is by nature a scavenger, which picks up and transports trace amounts of materials that it encounters in its environment. Municipally treated water generally is chemically treated to kill and/or remove disease-causing pathogens. However, water that emerges from this chemical treatment tends to retain trace amounts of the chemicals used during that treatment, and there is a demand for devices and systems that can reduce and remove those trace amounts of chemicals before the treated water reaches a consumer. Moreover, there exists a known demand for devices that can filter water in diverse situations—e.g. the whole household, at camping sites, or at the sites of natural disasters—in order to provide potable water. Various devices and approaches have been devised to meet this demand, some of which are reviewed here.

U.S. Pat. No. 5,569,374 discloses a portable drinking water filtration apparatus for filtering and purifying water, comprising a housing, a chamber formed inside the housing having an inlet opening, a first outlet opening, and a second outlet opening, filtration media positioned inside the chamber between the chamber inlet opening and the chamber outlet openings, and a pump mounted on the housing for forcing water through the filtration media, the second chamber outlet opening being in contact with the first chamber outlet opening for venting air as water is forced through the filtration media and discharged from the first chamber outlet opening and for discharging water from the chamber when the first chamber outlet opening is plugged. A plurality of bottle connection members are formed on the housing adjacent to the first chamber outlet opening for connecting the housing to a variety of different sized bottles.

U.S. Pat. No. 6,004,460 discloses a combination filter assembly and flexible, portable bottle having a bottom opening with a sealing cap attached thereto. The filter assembly may be attached to an adapter sealed to the top of the flexible bottle. Water in the bottle passes through the filter assembly and out a top nozzle or valve when the flexible bottle is squeezed. The flexible bottle is filled with water through the bottom opening.

U.S. Pat. No. 6,344,146 discloses a portable, self-contained, fully integrated water purification device which includes a receptacle modified to accommodate a filtration assembly for purifying water, and to store water following purification. The receptacle provides separate openings for water intake, and water outflow. The filtration assembly includes a pump and a multistage filter cartridge. Pump action draws water into the water purification device and forces the water through the multistage filter and into the receptacle. Purified water may be stored in the receptacle until consumption.

U.S. Pat. No. 6,536,637 discloses a combination backpack and cooler for transporting consumables on the back of a user. The combination backpack and cooler includes a main body portion having a front panel, a back panel, a pair of side panels, a top panel and a bottom panel. One of the side panels has an aperture extending therethrough. Each of a pair of straps has a first end coupled the top and a second end coupled the bottom. A container is located in the main body. The container has a spout fluidly coupled thereto and positioned for extending through the aperture in the main body. A cover member is adapted for frictionally engaging an edge of an opening of the spout for closing the spout.

U.S. Pat. No. 6,919,025 discloses a portable drinking device that can be filled with municipal type water, and which will remove impurities from that water. The portable drinking device is designed so that a person can carry around a single drinking device, fill that drinking device with type water (e.g. from a faucet), and yet have a portable water source more suitable to that person's water quality preferences. The portable drinking device has an integrally contained filtration component, designed for filtering water that is drawn or otherwise delivered from the device through a drinking tube or other delivery mechanism, and in a way designed to ensure that all water obtained from the device is passed through the filtration component to remove the desired impurities. In addition, some applications of this design will include a filtration component with a filter media that can be conveniently replaced, so that the same portable drinking structure can be used and reused, while other applications may include a filtration component designed as a single use, disposable filter.

U.S. Pat. No. 7,044,343 discloses a backpack containing a gravity flow water filtration system. The backpack incorporates a compartment at its top to hold a reservoir of untreated water, and a compartment at the bottom to hold a reservoir for filtered water. A tube and filter connect the two compartments, and a drinking tube and mouthpiece allow the user of the backpack to drink filtered water from the filtered water reservoir. In some embodiments, the bottom compartment is accessible from both ends, and can store other items as well.

U.S. Pat. No. 7,073,688 discloses a hydration system that includes a fluid reservoir and may be housed within a pack. Drink fluid is drawn from the reservoir through a drink tube to a mouthpiece. In some embodiments, the drink tube is connected to the reservoir at an exit port, the hydration system includes a manually actuated on/off valve, a filter, a pump, and/or a bite-actuated mouthpiece. A quick-connect assembly fluidly interconnects components of the hydration system and is configured to quickly release, and permit reattachment of, the detached components or replacement components. In some embodiments, the replacement components enable different performance from the detached components. In some embodiments, the quick-connect assembly is adapted to selectively couple a bite-actuated mouthpiece and a gas mask adapter to the drink tube. In some embodiments, at least a portion, if not the entire, hydration system is formed from a chemically resistant material.

U.S. Pat. No. 7,514,006 discloses a lightweight water treatment system which can be easily distributed and employed by disaster survivors for treating locally available water sources. The lightweight water treatment system includes a water treatment agent for treating a predetermined volume of water collected from a local water source; a collapsible elongated container for collecting the predetermined volume of water; one or more straps to transport the collapsible elongated container to a suitable location for treating the collected water with the water treatment agent and a spigot for controllably releasing the treated water.

U.S. Pat. No. 8,287,729 discloses a lightweight water treatment system which can be easily distributed and employed by disaster survivors for treating locally available freshwater sources. The water treatment system includes an internal storage volume for maintaining a predetermined volume of water, a water fill port in communication with the internal storage volume provided at a first end of the elongated container for receiving the predetermined volume of water, a sealing member disposed at about the first end of the elongated container for maintaining the volume of water within the internal storage volume, a second end of the elongated container for receiving sediment settling out of the predetermined volume of water and a discharge port disposed superjacent to the second conically-shaped end for controllably releasing at least a portion of the water maintained within the internal storage volume of the elongated container.

U.S. Pat. No. 8,887,924 discloses a water purification system that includes a container and a filter coupled to an outlet port of the container. The container includes a first layer and a second layer of polymeric material. A first edge of the first layer is bonded to a first edge of the second layer. A second edge of the first layer is bonded to a second edge of the second layer. A first end of the first layer is bonded to a first end of the second layer. The outlet port is disposed in the first layer at a first distance from the first end. A flat water filter is also described. A method for treating water is also described.

U.S. Patent Application Publication Number 2016/0347627 discloses a liquid purifying apparatus integrating a filter assembly and an ultraviolet light disinfection assembly that are suitable for portable water purification. A first apparatus includes a container, a cap assembly including a filter removably coupled to a first opening of the container and a disinfection assembly coupled to a second opening of the container and adapted to emit UV light to disinfect liquid in the container. A second apparatus includes upper and lower reservoirs, a filter assembly between the reservoirs, a disinfection assembly coupled to an opening in the lower reservoir and adapted to emit UV light to disinfect liquid in the lower reservoir and a spout in fluid communication with the lower reservoir

A need is still felt for a portable water filtration assembly adapted to hold multiple independently replaceable water filtration units.

### SUMMARY OF THE INVENTION

Disclosed herein are various example embodiments of a portable water filtration assembly including a carrying case adapted to hold multiple water filtration units. The interior of the case holds three water filtration units arranged in series. The filtration units are in fluid communication with each other through fluid connectors. The assembly includes a water input member and a water output member, each generally positioned at opposing ends of the case, each partially exposed to the space outside the case through apertures in the walls of the case, and each providing fluid communication between the outside world and the water filtration subassembly.

Thus, in some example embodiments of the present general inventive concept, a portable water filtration assembly for use in filtering water comprises a split case to hold water filtration units within an interior of said split case, said split case adapted to divide into two pieces to permit access to water filtration units held within said interior of said split case, said split case including access apertures permitting water to pass into the interior of said split case; a water filtration subassembly including a plurality of water filtration units operating in series to filter water, said water filtration units adapted to be replaced independently of the split case, each water filtration unit adapted to be replaced independently of each other water filtration unit in said water filtration subassembly and connectors adapted to permit the passage of water from one water filtration unit to another water filtration unit; a water input member positioned proximate a first access aperture in said split case, said water input member to pass water to a water filtration unit in said water filtration subassembly; and a water output member positioned proximate a second access aperture in said split case, said water output member to pass water from the interior of said split case to a position outside said split case after the water has passed through the plurality of water filtration units included in the water filtration subassembly.

In some example embodiments of the present general inventive concept, a portable water filtration assembly for use in filtering water comprises a water filtration subassembly including a first water filtration unit, a second water filtration unit, and a third water filtration unit, said water filtration units operating in series to filter water, said water filtration units adapted to be replaced independently of the split case, each water filtration unit adapted to be replaced independently of each other water filtration unit in said water filtration subassembly, and connectors adapted to permit the passage of water from the first water filtration unit to the second water filtration unit and from the second water filtration unit to the third water filtration unit; a split case adapted to hold said water filtration subassembly, said split case including access apertures permitting water to pass into water filtration subassembly.

Some embodiments further comprise a water input member positioned proximate a first access aperture in said split case, said water input member to pass water to said first water filtration unit in said water filtration subassembly, and a water output member positioned proximate a second access aperture in said split case, said water output member to pass water from said third water filtration unit to a position outside said split case after the water has passed through the first water filtration unit, the second water filtration unit, and the third water filtration unit.

In some embodiments, each water filtration unit comprises a filtration element, an outer housing to hold the filtration element, and a cap member adapted to mate with the outer housing, said cap member providing fluid access to the filtration element when said filtration element is held within the outer housing, said cap member adapted to connect in fluid communication with either two of said connectors or with one connector and one of either said water input member or said water output member, wherein said outer housing is detachable and reattachable to said cap member, whereby each filtration element is replaceable independently of the outer housing holding said filtration element.

### FIGURES

The above-mentioned and additional features of the invention will become more clearly understood from the following detailed description of the invention read together with the drawings in which:

FIG. 1 is a perspective view of an assembly according to one example embodiment of the present general inventive concept, showing a carrying case adapted to hold water filtration units;

FIG. 2 is an exploded view of the example embodiment assembly shown in FIG. 1, showing the interior of the case;

FIG. 3 is a perspective view of an example embodiment water filtration unit;

FIG. 4 is an exploded view of the water filtration unit shown in FIG. 3;

FIG. 5 is a section view of the example embodiment assembly shown in FIGS. 1 and 2;

FIG. 6A is a view of a first example embodiment water output member adapted to be used with an assembly according to the present general inventive concept;

FIG. 6B is a view of a second example embodiment water output member adapted to be used with an assembly according to the present general inventive concept;

FIG. 6C is a view of a third example embodiment water output member adapted to be used with an assembly according to the present general inventive concept;

FIG. 7 is a view of an assembly according to one example embodiment of the present general inventive concept in use with an outdoor residential water supply/irrigation system;

FIG. 8 is a view of an assembly according to one example embodiment of the present general inventive concept in use with a residential plumbing system; and

FIG. 9 is a view of an assembly according to one example embodiment of the present general inventive concept in use with a gravity fed water supply.

### DETAILED DESCRIPTION

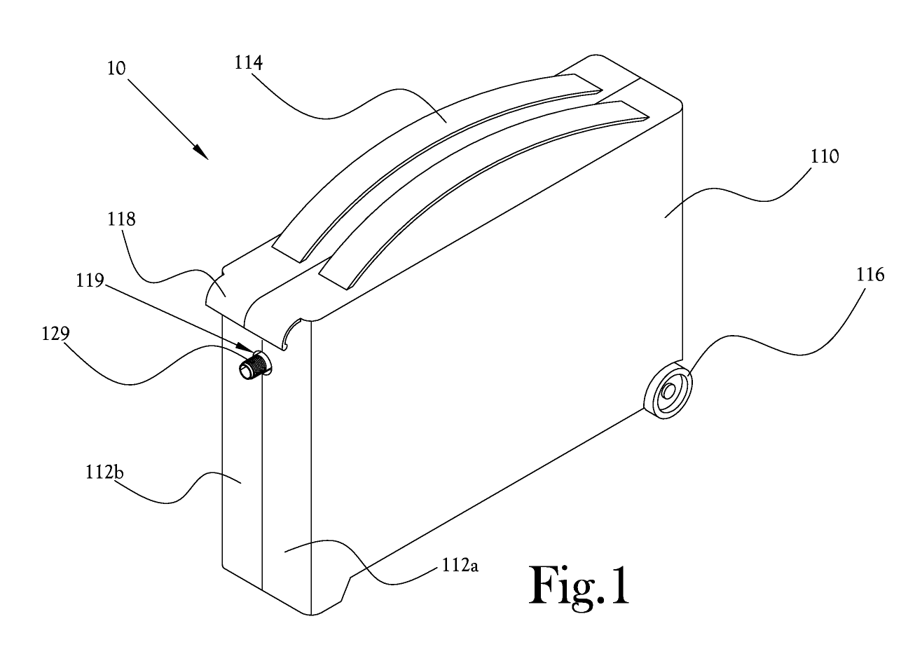

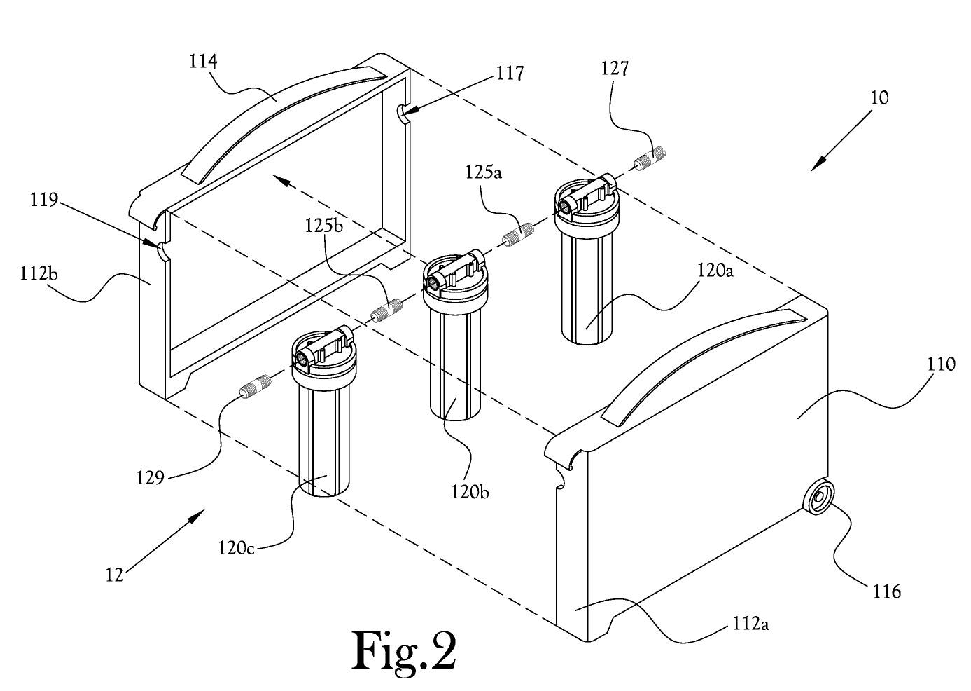

Turning to the Figures, FIG. 1 shows an assembly 10 according to one example embodiment of the present general inventive concept, showing a split case 110 adapted to hold water filtration units. FIG. 2 is an exploded view of the same assembly 10 shown in FIG. 1, showing the interior of the split case 110 and three water filtration units 120a, 120b, 120c arranged in series. The split case 110 is designed to divide into two pieces, 112a and 112b, as shown in FIG. 2, permitting access to the interior of the case 110 and the water filtration units 120a, 120b, 120c held within. As shown in FIG. 1, the example embodiment split case 110 includes at least one strap or handle 114 (hereafter collectively “strap”) attached to an exterior surface of the split case 110 and adapted to allow a user to carry the split case 110. The example embodiment split case 110 also includes at least one rolling wheel 116 positioned on or near an exterior surface of the split case 110, with the rolling wheel 116 or wheels adapted to roll along a floor or ground surface, thereby allowing a user to transport the split case 110 by pulling the split case 110 in such a manner that the rolling wheel 116 or wheels remain on the floor or ground surface, easing transport of the split case 110. Further, the illustrated example embodiment includes a handle 118 adapted to be grasped by a user during transport of the split case 110. The filtration units 120a, 120b, 120c are positioned within an interior volume defined by the walls of the split case 110, and the filtration units 120a, 120b, 120c are in fluid communication with each other through fluid connectors 125a, 125b. (The filtration elements housed within the interior volume defined by the walls of the split case 110—i.e., the filtration units 120a, 120b, 120c and the fluid connectors 125a, 125b—collectively may be designated as the water filtration subassembly 12.) Further, the assembly 10 includes a water input member 127 (shown in FIG. 2) and a water output member 129, each generally positioned at opposing ends of the split case 110, each partially exposed to the space outside the split case 110 through access apertures 117, 119 in the walls of the split case 110, and each providing fluid communication between the outside world and the water filtration subassembly 12.

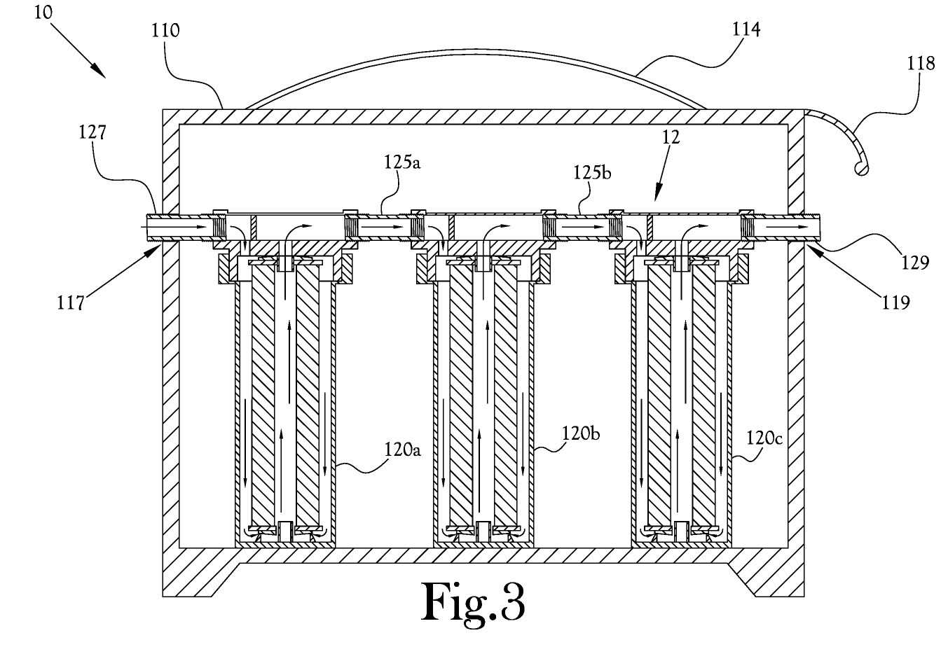

FIG. 3 is a section view of the example embodiment assembly shown in FIGS. 1 and 2, illustrating the direction of water flow within the assembly 10. As seen in FIG. 3, water to be filtered enters the assembly 10 through the water input member 127 (positioned within the first access aperture 117) and proceeds to pass, in succession, through the first filtration unit 120a, the first fluid connector 125a, the second filtration unit 120b, the second fluid connector 125b, and the third filtration unit 120c. The water, having passed through three filtration units, then exits the assembly through the water output member 129 (positioned within the second access aperture 119, located, in this embodiment, on a wall opposite the first access aperture 117).

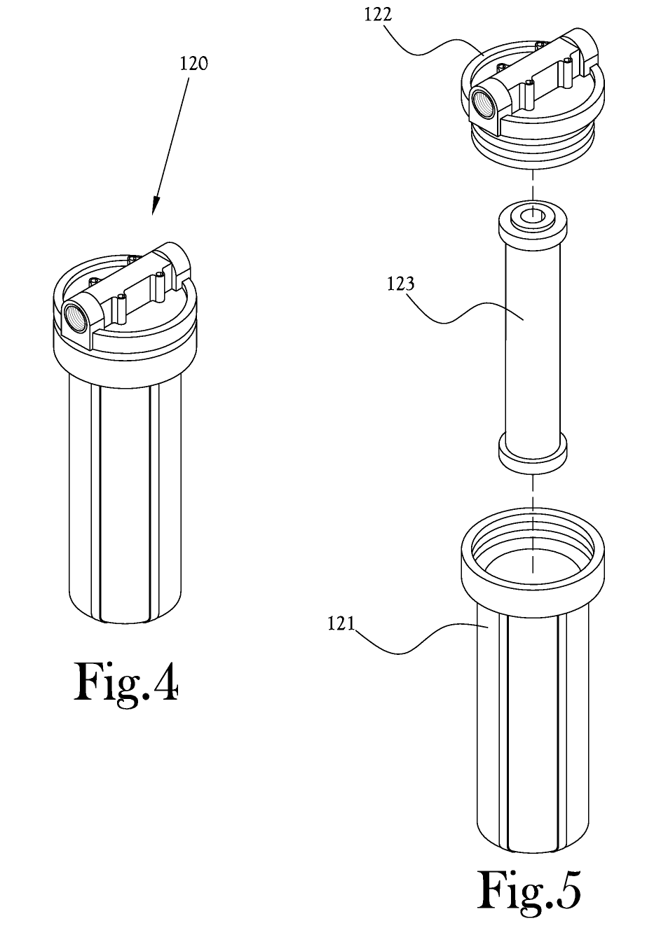

FIG. 4 is a perspective view of an example embodiment water filtration unit 120. FIG. 5 is an exploded view of the water filtration unit 120 shown in FIG. 4. As shown in FIGS. 4 and 5, the example embodiment water filtration unit 120 includes an outer housing 121 with an open top, a cap member 122 adapted to fit with or onto the top of the outer housing 121, and a filtration element 123 adapted to fit within the outer housing 121 when the cap member 122 is fit with or onto the top of the outer housing 121. The example embodiment water filtration unit 120 shown in FIGS. 4 and 5, configured to be disassembled by a user, permits replacement of a spent filtration element 123 without requiring replacement or discard of the outer housing 121 or cap member 122. A number of filtration elements 123 are known in the art and contemplated by the present general inventive concept, including (but not limited to) filtration elements that include ceramic materials, polymers, bonded silver nanoparticles, and/or activated charcoal.

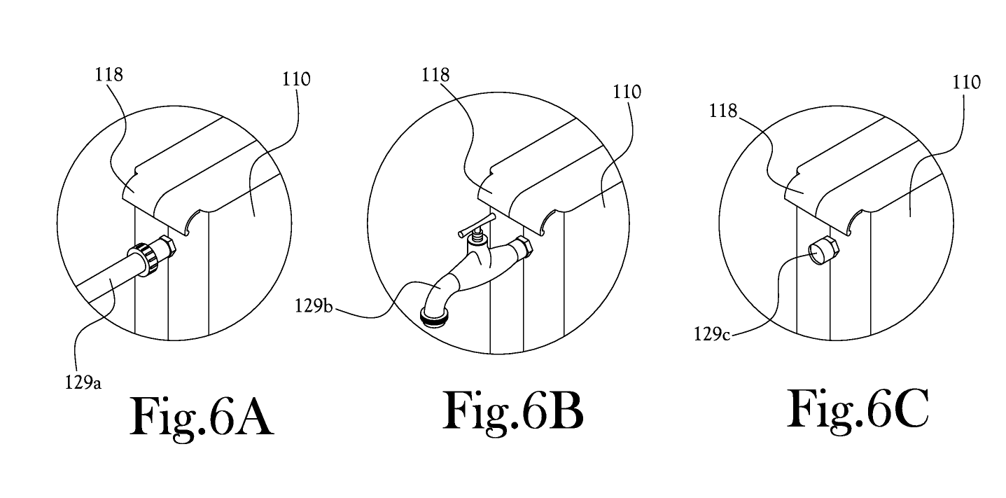

FIG. 6A is a view of a first example embodiment water output member adapted to be used with an assembly according to the present general inventive concept. The example embodiment shown in FIG. 6A comprises a water output member 129a that connects with existing plumbing fixtures and/or tubing.

FIG. 6B is a view of a second example embodiment water output member adapted to be used with an assembly according to the present general inventive concept. The example embodiment shown in FIG. 6B comprises a water output member 129b that functions as a spigot.

FIG. 6C is a view of a third example embodiment water output member adapted to be used with an assembly according to the present general inventive concept. The example embodiment shown in FIG. 6C comprises a water output member 129c configured to connect with a hose or other line.

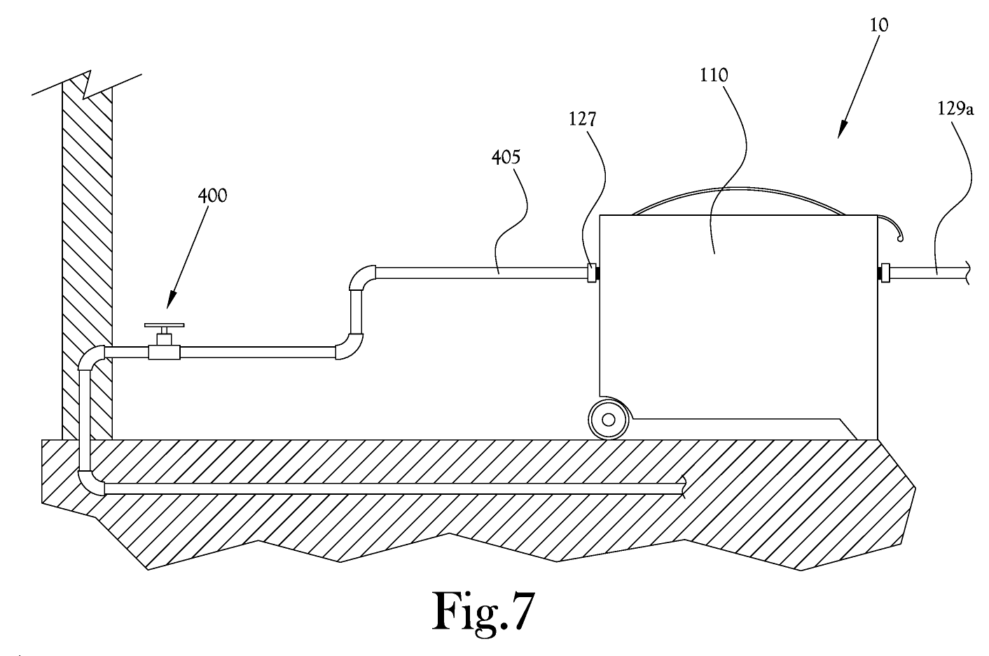

FIG. 7 is a view of an assembly 10 according to one example embodiment of the present general inventive concept in use with an outdoor residential water supply/irrigation system 400. As shown in FIG. 7, the split case 110 is in fluid communication with the outdoor residential water supply/irrigation system 400 through a water line 405 connected to the water input member 127. Water passes through the water line 405 and thence through the water input member 127 into the water filtration subassembly inside the split case 110.

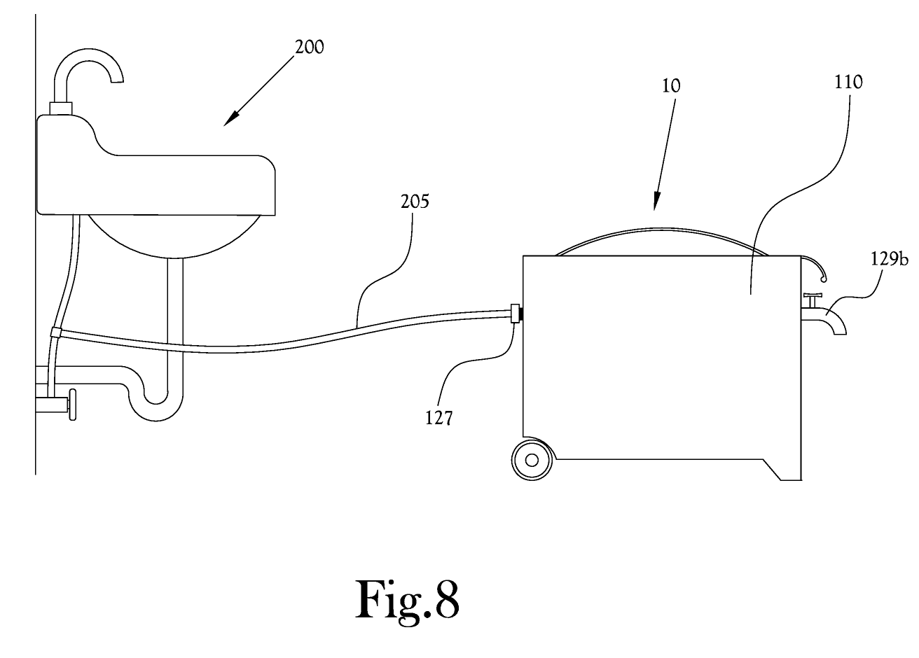

FIG. 8 is a view of an assembly 10 according to one example embodiment of the present general inventive concept in use with a residential plumbing system 200. As shown in FIG. 8, the split case 110 is in fluid communication with the residential plumbing system 200 through a water line 205 connected to the water input member 127. Water passes through the water line 205 and thence through the water input member 127 into the water filtration subassembly inside the split case 110.

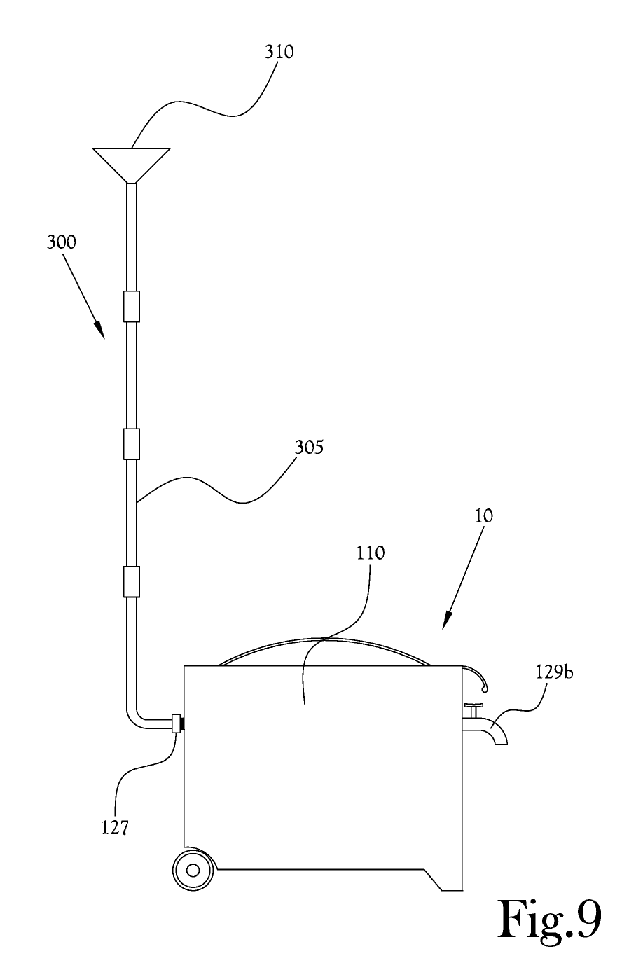

FIG. 9 is a view of an assembly 10 according to one example embodiment of the present general inventive concept in use with a gravity fed water supply system 300. As shown in FIG. 9, a gravity fed water supply system 300 includes a water line 305 and a funnel 310, with the water line 305 configured to connect to the water input member 127 providing access to the interior of the split case 110. The water line 305 includes a substantially vertical section and two ends, with the funnel 310 is connected to the water line 305 at one end and the water input member 127 connected to the water line 305 at the other end. Water passes through the water line 305 and thence through the water input member 127 into the water filtration subassembly 12 inside the split case 110. In some embodiments, the substantially vertical section of the water line 305 is approximately 48 inches in height. In some embodiments of the present general inventive concept, the water line 305 and funnel 310 are accessory items adapted to be moved with the assembly 10, in some instances held in a separate carrying vessel or bag that can be transported along with the split case 110 until the gravity fed water supply system 300 is assembled.

Other configurations will be apparent to those of skill in the art and are also within the scope of the present general inventive concept.

Thus, in some example embodiments of the present general inventive concept, a portable water filtration assembly for use in filtering water comprises a split case to hold water filtration units within an interior of said split case, said split case adapted to divide into two pieces to permit access to water filtration units held within said interior of said split case, said split case including access apertures permitting water to pass into the interior of said split case; a water filtration subassembly including a plurality of water filtration units operating in series to filter water, said water filtration units adapted to be replaced independently of the split case, each water filtration unit adapted to be replaced independently of each other water filtration unit in said water filtration subassembly and connectors adapted to permit the passage of water from one water filtration unit to another water filtration unit; a water input member positioned proximate a first access aperture in said split case, said water input member to pass water to a water filtration unit in said water filtration subassembly; and a water output member positioned proximate a second access aperture in said split case, said water output member to pass water from the interior of said split case to a position outside said split case after the water has passed through the plurality of water filtration units included in the water filtration subassembly.

In some embodiments, said water filtration subassembly comprises three water filtration units.

In some embodiments, said portable water filtration assembly is adapted to be used with an exterior water supply. In some embodiments, said portable water filtration assembly is adapted to be used with a residential water system. In some embodiments, said portable water filtration assembly is adapted to be used with a gravity-fed water supply.

In some embodiments, said portable water filtration assembly is adapted to be used in disaster recovery efforts.

Some embodiments further comprise rolling wheels attached to an exterior surface of said split case to facilitate movement of said split case.

Some embodiments further comprise a strap attached to an exterior surface of said split case to facilitate carrying of said split case.

Some embodiments further comprise a handle attached to an exterior surface of said split case to facilitate movement of said split case.

In some example embodiments of the present general inventive concept, a portable water filtration assembly for use in filtering water comprises a water filtration subassembly including a first water filtration unit, a second water filtration unit, and a third water filtration unit, said water filtration units operating in series to filter water, said water filtration units adapted to be replaced independently of the split case, each water filtration unit adapted to be replaced independently of each other water filtration unit in said water filtration subassembly, and connectors adapted to permit the passage of water from the first water filtration unit to the second water filtration unit and from the second water filtration unit to the third water filtration unit; a split case adapted to hold said water filtration subassembly, said split case including access apertures permitting water to pass into water filtration subassembly.

Some embodiments further comprise a water input member positioned proximate a first access aperture in said split case, said water input member to pass water to said first water filtration unit in said water filtration subassembly, and a water output member positioned proximate a second access aperture in said split case, said water output member to pass water from said third water filtration unit to a position outside said split case after the water has passed through the first water filtration unit, the second water filtration unit, and the third water filtration unit.

In some embodiments, each water filtration unit comprises a filtration element, an outer housing to hold the filtration element, and a cap member adapted to mate with the outer housing, said cap member providing fluid access to the filtration element when said filtration element is held within the outer housing, said cap member adapted to connect in fluid communication with either two of said connectors or with one connector and one of either said water input member or said water output member, wherein said outer housing is detachable and reattachable to said cap member, whereby each filtration element is replaceable independently of the outer housing holding said filtration element.

Various example embodiments of the present general inventive concept provide a portable water filtration assembly adapted to hold multiple independently replaceable water filtration units. Such a portable water filtration assembly is frequently adapted for use in disaster recovery efforts. Moreover, a portable water filtration assembly according to various example embodiments of the present general inventive concept is adapted to reduce and remove dead pathogens and trace amounts of treatment chemicals in water that has been treated with pathogen-killing chemicals, such as those used in many municipal water treatment systems.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A portable water filtration assembly for use in filtering water, comprising:
a split case to hold water filtration units within an interior of said split case, said split case adapted to divide into two pieces to permit access to water filtration units held within said interior of said split case, said split case including access apertures permitting water to pass into the interior of said split case;
a water filtration subassembly including:
a plurality of water filtration units operating in series to filter water, said water filtration units adapted to be replaced independently of the split case, each water filtration unit adapted to be replaced independently of each other water filtration unit in said water filtration subassembly; and
connectors adapted to permit the passage of water from one water filtration unit to another water filtration unit;
a water input member positioned proximate a first access aperture in said split case, said water input member to pass water to a water filtration unit in said water filtration subassembly; and
a water output member positioned proximate a second access aperture in said split case, said water output member to pass water from the interior of said split case to a position outside said split case after the water has passed through the plurality of water filtration units included in the water filtration subassembly.

2. The portable water filtration assembly of claim 1, wherein said water filtration subassembly comprises three water filtration units.

3. The portable water filtration assembly of claim 1, wherein said portable water filtration assembly is adapted to be used with an exterior water supply.

4. The portable water filtration assembly of claim 1, wherein said portable water filtration assembly is adapted to be used with a residential water system.

5. The portable water filtration assembly of claim 1, wherein said portable water filtration assembly is adapted to be used with a gravity-fed water supply.

6. The portable water filtration assembly of claim 1, wherein said portable water filtration assembly is adapted to be used in disaster recovery efforts.

7. The portable water filtration assembly of claim 1 further comprising rolling wheels attached to an exterior surface of said split case to facilitate movement of said split case.

8. The portable water filtration assembly of claim 1 further comprising a strap attached to an exterior surface of said split case to facilitate carrying of said split case.

9. The portable water filtration assembly of claim 1 further comprising a handle attached to an exterior surface of said split case to facilitate movement of said split case.

10. A portable water filtration assembly for use in filtering water, comprising:
a water filtration subassembly including:
a first water filtration unit, a second water filtration unit, and a third water filtration unit, said water filtration units operating in series to filter water, said water filtration units adapted to be replaced independently of the split case, each water filtration unit adapted to be replaced independently of each other water filtration unit in said water filtration subassembly; and
connectors adapted to permit the passage of water from the first water filtration unit to the second water filtration unit and from the second water filtration unit to the third water filtration unit;
a split case adapted to hold said water filtration subassembly, said split case including access apertures permitting water to pass into water filtration subassembly.

11. The portable water filtration assembly of claim 10 further comprising:
a water input member positioned proximate a first access aperture in said split case, said water input member to pass water to said first water filtration unit in said water filtration subassembly; and
a water output member positioned proximate a second access aperture in said split case, said water output member to pass water from said third water filtration unit to a position outside said split case after the water has passed through the first water filtration unit, the second water filtration unit, and the third water filtration unit.

12. The portable water filtration assembly of claim 10 wherein each water filtration unit comprises a filtration element, an outer housing to hold the filtration element, and a cap member adapted to mate with the outer housing, said cap member providing fluid access to the filtration element when said filtration element is held within the outer housing, said cap member adapted to connect in fluid communication with either two of said connectors or with one connector and one of either said water input member or said water output member, wherein said outer housing is detachable and reattachable to said cap member, whereby each filtration element is replaceable independently of the outer housing holding said filtration element.

13. The portable water filtration assembly of claim 10 further comprising rolling wheels attached to an exterior surface of said split case to facilitate movement of said split case.

14. The portable water filtration assembly of claim 10 further comprising a strap attached to an exterior surface of said split case to facilitate carrying of said split case.

15. The portable water filtration assembly of claim 10 further comprising a handle attached to an exterior surface of said split case to facilitate movement of said split case.

16. The portable water filtration assembly of claim 10, wherein said portable water filtration assembly is adapted to be used in disaster recovery efforts.
